(19) United States
(12) Patent Application Publication
(10) Pub. No.: US 2002/0171207 A1
(43) Pub. Date: Nov. 21, 2002

(54) Terminal integrated seal member

(75) Inventors: Chieko Torii, Shizuoka (JP); Takao Murakami, Shizuoka (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION.

(21) Appl. No.: 10/145,721

(22) Filed: May 16, 2002

(30) Foreign Application Priority Data
May 18, 2001 (JP) 2001-150179

(51) Int. Cl. F16L 5/02

(52) U.S. Cl. 277/607

(57) ABSTRACT

A seal member is provided with a tube portion closely contacted with an inserted electric wire so as to be waterproof, and a sleeve portion including a through hole communicated with the tube portion, and one or more elastically deforming projections formed in an outer periphery thereof. The projections are elastically deformed by caulking arms of an electric terminal and the sleeve portion, the terminal and the electric wire are closely fixed to each other in a case where the sleeve portion is caulked by the caulking arms.

### BACKGROUND OF THE INVENTION

1. Field of the Invention

The present invention relates to a rubber seal member used in a connector requiring a waterproofing property such as a wiring harness of an automobile or the like, and more particularly to a rubber seal member integrated by being caulked to a terminal.

2. Description of the Related Art

In a connector in which a waterproofing property is required, a waterproofing property is secured by fitting a rubber seal member to a terminal. Since an operation of engaging the terminal with the connector becomes laborious in the case that the seal member is separated from the terminal, a sleeve portion for being caulked by the terminal is frequently provided in the seal member so as to be integrally treated with the terminal.

As the rubber seal member provided with the sleeve portion as mentioned above, there has proposed arts disclosed in Japanese Patent Application Laid-Open Nos. 6-302352 and 7-282893.

In the rubber seal member disclosed in Japanese Patent Application Laid-Open No. 6-302352, a rib is formed in an inner side of the sleeve portion. When the sleeve portion is caulked by caulking arms provided in the terminal, the rib is compressively deformed, whereby a close contact between the terminal and the seal member, and between the seal member and an electric wire is more firmly executed.

The rubber seal member disclosed in Japanese Patent Application Laid-Open No. 7-282893 is provided with an annular groove in an outer periphery of the sleeve portion so that a contact area with respect to caulking arms provided in the terminal becomes large, and the seal member is more securely fixed.

### SUMMARY OF THE INVENTION

Since the seal member proposed by Japanese Patent Application Laid-Open No. 6-302352 is structured such that a rib prevents the electric wire from being inserted, there is a disadvantage that it is hard to execute an assembling operation. Since the seal member proposed by Japanese Patent Application Laid-Open No. 7-282893 is structured such that the contact area is increased, it is necessary to secure a surface pressure by increasing a rigidity of the caulking arms. Accordingly, there are problems that a shape is enlarged, a weight is increased, and a production cost is increased.

An object of the present invention is to provide a rubber seal member, which can obtain a sufficient adhesion by a simple assembling operation, and is integrated with a terminal.

According to a first aspect of the present invention, a seal member includes a tube portion closely contacted with an inserted electric wire so as to be waterproof, and a sleeve portion including a through hole communicated with the tube portion, and one or more elastically deforming projections formed in an outer periphery thereof. The projections are elastically deformed by caulking arms of an electric terminal and the sleeve portion, the terminal and the electric wire are closely fixed to each other in a case where the sleeve portion is caulked by the caulking arms.

In the structure mentioned above, the projection elastically deforms so as to store a contact pressure, thereby a sufficient contact force can be obtained. Accordingly, the seal member can be securely prevented from displacing, on the basis of a simple assembling operation.

According to a second aspect of the present invention, the projection is a rib annularly surrounding an outer periphery of the sleeve portion.

According to the structure mentioned above, in addition to the effect mentioned above, the sleeve portion contacts with the caulking arm uniformly in a peripheral direction, so that a further stable contact force can be obtained.

According to a third aspect of the present invention, the projections are plurally formed.

According to the structure mentioned above, when caulking the sleeve portion by the caulking arm, the projection is pressure contacted with the caulking arm, and a high pressure is concentrically generated. Accordingly, a higher contact force than that in the first aspect can be obtained.

According to a fourth aspect of the present invention, the seal member has the same structure as mentioned above, and the sleeve portion comprises a flange integrally at a front end thereof. When caulking the sleeve portion by the caulking arm, the flange is not in contact with the caulking arm.

According to the structure mentioned above, since the caulking arm is not in contact with the flange, the caulking arm does not damage the flange even in the case that the flange is temporarily deformed due to the force. Since the flange is hard to be damaged, the flange securely serves as a come-off prevention effect at a time when the force of drawing out the seal member is applied.

### BRIEF DESCRIPTION OF THE DRAWINGS

FIG. 1 is a perspective view of a seal member according to an embodiment of the present invention;

FIG. 2 is a cross sectional view showing a main portion of the seal member according to the embodiment of the present invention;

FIG. 3 is a perspective view of a seal member according to a first modified embodiment in the embodiment of the present invention;

FIG. 4 is a perspective view of a seal member according to a second modified embodiment in the embodiment of the present invention; and

FIG. 5 is a perspective view showing a state of fixing the seal member to a terminal and an electric wire according to the embodiment of the present invention.

### DETAILED DESCRIPTION OF THE PREFERRED EMBODIMENT

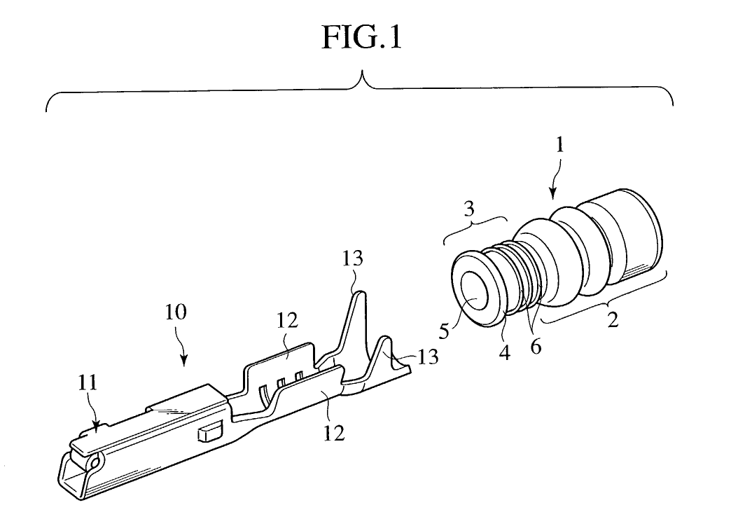

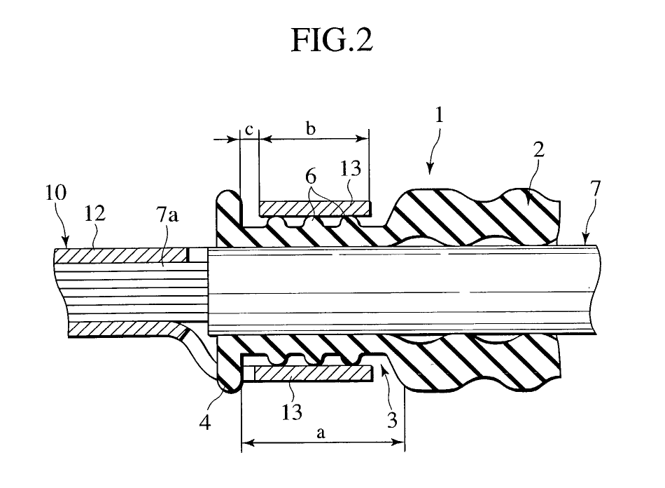

A description will be given of an embodiment according to the present invention with reference to FIGS. 1 and 2.

A terminal 10 to which a seal member 1 is mounted, is integrally provided with a connection portion 11 to which an opposing connector (not shown) is connected, in a front end thereof, a pair of contact arms 12 at the rear of the connection portion 11, and a pair of caulking arms 13 at the rear thereof, as shown in FIG. 1.

The seal member 1 according to the present embodiment is made of rubber having a sufficient elasticity, and is formed substantially in a cylindrical shape as a whole, as shown in FIGS. 1 and 2. The seal member 1 is provided with a tubular base portion 2 in a rear portion thereof, a sleeve portion 3 integrally formed in a front end of the tubular base portion 2, and a flange portion 4 formed in a front end of the sleeve portion 3. A through-hole 5 extending through in an axis direction is provided in an inner portion of the seal member 1.

The tubular base portion 2 is formed so as to be folded along an axial direction, as shown in FIG. 2. The sleeve 3 is constituted by a cylinder body having a smaller diameter than the tubular base portion 2, and is integrally provided with the flange 4 having a larger diameter than the sleeve 3 in an outer side of a front end thereof. A plurality of (three in the present embodiment) annular ribs 6 are integrally formed in an outer periphery of the sleeve portion 3, as shown in FIGS. 1 and 2. The number of the ribs 6 may be set to one, however, since a pair of caulking arms 13 are bent alternately so as to be press-contacted, it is preferable that a plurality of ribs are provided, for the purpose of securing a contact all around the periphery of the bent portion.

A size and a shape of the rib 6 may be optionally determined as far as a sufficient contact force is applied at a time when the caulking arm 13 is press-contacted. In addition to the structure shown in FIG. 2 in which a cross-section is a semicircular shape, structures having a cross section of a rectangular or triangular shape are exemplified.

A length a in the axial direction between the flange 4 and the tubular base portion 2 is set to be at least longer than a length b in a width direction of the caulking arm 13 press-contacted to this portion. Accordingly, the structure is made such that a front end of the caulking arm 13 is not in contact with the flange 4, in a state of bending a pair of caulking arms 13 along the outer periphery of the sleeve portion 3. That is, as shown in FIG. 2, the caulking arm 13 is mounted so that a gap is left between the front end surface of the caulking arm 13 and the flange 4 by a length c when the caulking arm 13 is press-contacted so as to involve the portion of the sleeve portion 3.

Next, a description will be given of a method of mounting the seal member 1 to the terminal 10.

At first, as shown in FIG. 2, a terminal of an insulating cover in a covered electric wire 7 is removed and a front end of an electric wire 7a is exposed. This is inserted into the through-hole 5 from the rear end of the seal member 1 and is passed to the front end so as to be held.

Next, a pair of contact arms 12 is caulked so as to be press-contacted with the electric wire 7a of the covered electric wire 7 which is held by the seal member 1.

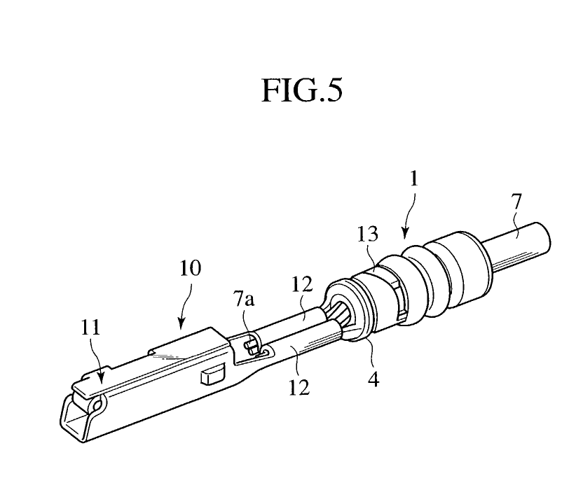

Further, a pair of caulking arms 13 in the terminal 11 is bent along the outer peripheral surface of the sleeve portion 3 in the seal member 1 so as to be press-contacted, thereby being in a state shown in FIG. 5.

The ribs 6 of the sleeve portion 3 which is press-contacted by the caulking arms 13 elastically deform, whereby a contact pressure is stored, thereby applying a reaction force to a side of the caulking arms 13. Accordingly, the caulking arms 13 become hard to slip with respect to the sleeve portion 3.

According to the present embodiment, as shown in FIG. 2, since the gap exists between the front end surfaces of the caulking arms 13 and the flange 4, the caulking arms 13 are not in contact with the flange 4, so that it is possible to prevent the flange from being damaged by the caulking arms 13. As mentioned above, according to the present embodiment, the flange 4 is hard to be damaged due to a slip prevention effect generated by the pressing of the caulking arms 13 to the ribs 6, and a pressing effect between the terminal 10 and the seal member 1, and in the unlikely event that the caulking force of the caulking arms 13 is loosened, the flange 4 is caught on the caulking arms 13 so as to be prevented from displacing.

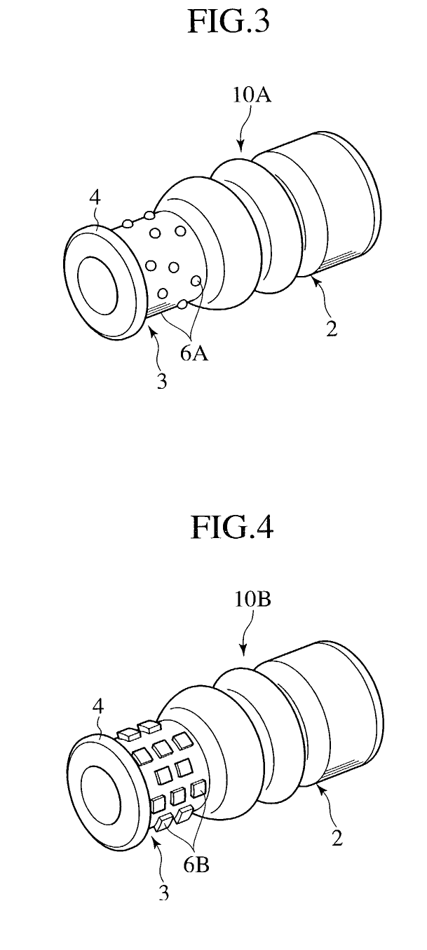

Although the invention has been described above by reference to certain embodiments of the invention, the invention is not limited to the embodiments described above. Modifications and variations of the embodiments described above will occur to those skilled in the art, in light of the above teachings. For example, the outer peripheral surface of the sleeve portion 3 may be provided with a plurality of semi-spherical projections 6A shown in FIG. 3, in place of the annular ribs 6 as shown in FIG. 2. Further, in place of the ribs 6, it is possible to employ a plurality of projections 6B having a rectangular cross section shown in FIG. 4. Further, it is possible to mix these projections. The seal member may be made of synthetic resin in place of rubber.

What is claimed is:

1. A seal member comprising:
a tube portion closely contacted with an inserted electric wire so as to be waterproof; and
a sleeve portion including a through hole communicated with the tube portion, and one or more elastically deforming projections formed in an outer periphery thereof,
wherein the projections are elastically deformed by caulking arms of an electric terminal, and the sleeve portion, the terminal and the electric wire are closely fixed to each other in a case where the sleeve portion is caulked by the caulking arms.

2. A seal member as claimed in claim 1, wherein:
each projection is an annular rib surrounding an outer periphery of the sleeve portion.

3. A seal member as claimed in claim 1, wherein:
the projections are plurally formed.

4. A seal member as claimed in claim 1, wherein:,
the sleeve portion comprises a flange integrally at a front end thereof; and
the flange is not in contact with the caulking arm in a case where the sleeve portion is caulked by the caulking arms.
